(19) United States
(12) Patent Application Publication
(10) Pub. No.: US 2021/0209473 A1
(43) Pub. Date: Jul. 8, 2021

(54) Generalized Activations Function for Machine Learning

(71) Applicant: Intel Corporation, Santa Clara, CA (US)

(72) Inventors: Julio Cesar Zamora Esquivel, Zapopan (MX); Jesus Adan Cruz Vargas, Zapopan (MX); Nadine L. Dabby, Palo Alto, CA (US); Anthony Rhodes, Portland, OR (US); Omesh Tickoo, Portland, OR (US); Narayan Sundararajan, Palo Alto, CA (US); Lama Nachman, Santa Clara, CA (US)

(73) Assignee: Intel Corporation, Santa Clara, CA (US)

(21) Appl. No.: 17/212,747

(22) Filed: Mar. 25, 2021

(51) Int. Cl. G06N 3/08; G06N 3/04

(52) U.S. Cl. CPC G06N 3/08; G06N 3/049

(57) ABSTRACT

The present disclosure provides a machine learning model where each activation node within the model has an adaptive activation function defined in terms of an input and a hyperparameter of the model. Accordingly, each activation node can have a separate of distinct activation function, based on the adaptive activation function where the hyperparameter for each activation node is trained during overall training of the model. Furthermore, the present disclosure provides that a set of adaptive activation functions can be provided for each activation node such that a spike train of activations can be generated.

### TECHNICAL FIELD

The disclosure is directed towards machine learning algorithms and particularly to activation functions to process input to generate outputs at each node of a machine learning model.

### BACKGROUND

Machine learning, including deep learning, is increasingly used in modern computing to leverage large datasets to generate models. These models are often used to generate an inference about the world from a set of inputs. As a specific example, the inference can correspond to control inputs to, for example, robots, automobiles, industrial machinery, or the like. Generally speaking, a machine learning model comprises a network of interconnected nodes where each node is associated with an activation function. There are a number of different activation functions that can be selected for use in a machine learning model. Conventionally, selection of activations functions is a manual process, often based on a brute force empirical process. As can be imagined, this takes both a significant amount of skill as well as a significant amount of human resources to select the proper activation function for machine learning.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a comparison between image classification, object detection, and instance segmentation.

FIG. 2 illustrates an exemplary machine learning (ML) system suitable for use with the present disclosure.

FIG. 3 illustrates a region-based convolution neural network model 300 that can be provisioned according to the present disclosure.

FIG. 4 illustrates a convolutional neural network (CNN) 400 that can be provisioned according to the present disclosure.

FIG. 5A illustrates a first adaptive activation function (AAF), according to the present disclosure.

FIG. 5B illustrates a second adaptive activation function (AAF), according to the present disclosure.

FIG. 5C illustrates a third adaptive activation function (AAF), according to the present disclosure.

FIG. 5D illustrates a fourth adaptive activation function (AAF), according to the present disclosure.

FIG. 5E illustrates a fifth adaptive activation function (AAF), according to the present disclosure.

FIG. 5F illustrates a sixth adaptive activation function (AAF), according to the present disclosure.

FIG. 6A illustrates generating a spike train 612 from a set of adaptive activation functions (S_{AAF}), according to the present disclosure.

FIG. 6B illustrates generating the spike train 612 from the set of adaptive activation functions (S_{AAF}), according to the present disclosure in greater detail.

FIG. 7A illustrates a network 700a using AAFs, according to examples of the present disclosure.

FIG. 7B illustrates a network 700b using AAFs and spike trains, according to examples of the present disclosure.

FIG. 8 illustrates a table 800 showing experimental results of application of the present disclosure to various network topologies.

FIG. 9 illustrates a routine 900 in accordance with one embodiment.

FIG. 10 illustrates a computer-readable storage medium 1000 in accordance with one embodiment.

FIG. 11 illustrates an aspect of the subject matter in accordance with one embodiment.

### DETAILED DESCRIPTION

Generally, the present disclosure is directed towards machine learning techniques, machine learning models, and particularly to train a machine learning (ML) model where an activation function for each neuron, in each layer of the network, is also learned during the training process. As stated, ML models comprise a network of interconnected nodes where each node is associated with an activation function. Nodes are interconnected with weights and the ML model itself can be used to “infer” output from input to facilitate improvements to and/or operation of physical technology. As a number of specific examples, ML models can be trained to infer output for a computer vision system, output for a speech recognition system, output for a natural language processing system, output for an audio recognition system, output for a social network filtering system, output for a machine translation system, output for a bioinformatics system, output for a drug design system, output for a medical image analysis system, or output for a material inspection system. It is noted that these examples are provided for purposes of completeness of the disclosure and not to be limiting.

Said differently, the present disclosure provides that each “node” or “neuron” in the ML model is trained to learn it's own activation functions, referred to herein as a “adaptive activation function” as well as to “learn” (e.g., adjusting weights connecting nodes, etc.) occurring in the overall ML model training process. The present disclosure further provides to take each “adaptive activation function” of the individual nodes in the ML model and to generate a “spike train.” This is described in greater detail below, but generally, speaking, a spike train is a series of activations, as opposed to using a single scalar value like with conventional ML model node activations (e.g., rectified linear unit (ReLU) activation function, or the like).

It is noted that throughout the disclosure ML is used to generally describe the technological features of machines “learning” some behavior. However, these concepts are also often referred to artificial intelligence (AI) or other such names. No distinction is attempted to be made herein between AI, ML, or other such methodologies. Instead, ML is used to generally refer to the entire discipline.

Furthermore, the present disclosure provides to learn which activation functions to use during training of an ML model as well to provide a spike train of activations at each node in the ML model. This is described in greater detail below. However, an overview of ML as well as an example practical application are given first, to provide clarity and instruction on how the present disclosure solves concrete problems within the technological ML space. More specifically, these descriptions are provided to illustrate that the present disclosure does not merely use computers and technology as a tool to perform an abstract concept but instead provides for the improvement of underlying technological processes. These advantages will become evident from the disclosure.

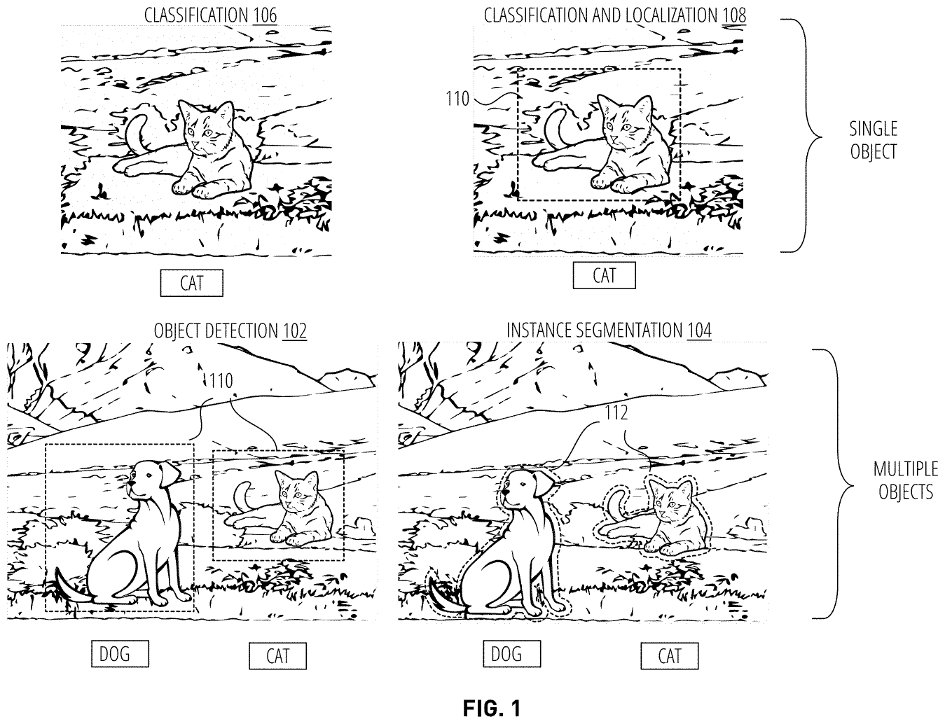

To that end, FIG. 1 illustrates a comparison between image classification, object detection, and instance segmentation. It is noted that ML models and ML model training algorithms can be provided according to the present disclosure wherein activations functions for each node are learned as well as each node can provide a spike train of activations. Such ML models and ML model training algorithms can be provided to “train” ML models to perform image classification, image recognition, or otherwise process images for purposes of “computer vision” applications. As such, the image classification example given by FIG. 1 is referenced throughout the disclosure to provide context and clarity to the description. However, it is noted that the present disclosure can be applied to train ML models for application other than image classification. For example, the present disclosure can be implemented to learn relationships between biological cells (e.g., DNA, proteins, etc.), control behaviors for devices, learn to control robots, or the like.

Referring to FIG. 1, when a single object is in an image, the classification model 106 maybe utilized to identify what is in the image. For instance, the classification model 106 identifies that a cat is in the image. In addition to the classification model 106, a classification and localization model 108 may be utilized to classify and identify the location of the cat within the image with a bounding box 110. When multiple objects are present within an image, an object detection model 102 may be utilized. The object detection model 102 may utilize bounding boxes to classify and locate the position of the different objects within the image. An instance segmentation model 104 can be applied to detect each object of an image, its localization and its precise segmentation by pixel with a segmentation region 112.

Generally speaking, models 102 and 104 can classify images into a single category usually corresponding to the most salient object. However, photos and videos are usually complex and contain multiple objects. Assigning a label with image classification models may become tricky and uncertain. As such, models 106 and 108 can be applied to identify multiple relevant objects in a single image as well as to provide indications of localization of the detected objects.

In general, the present disclosure is applicable to a variety of different types of ML models where the nodes use activation functions to generate output, such as, artificial neural network (ANN) or a convoluted neural network (CNN). However, it is noted that specific ML model architecture can be selected based on design goals, available resources, size of the data sets available, or the like. It is noted that often ML model is used to refer to the “network” or structure with which an output is inferred or generated from a particular input. However, in some cases simply network is used. This is not to be limiting.

Examples of some types of specific ML models are region-based convolutional neural networks (R-CNN), fast region-based convolutional neural networks (Fast R-CNN), Faster region-based convolutional neural networks (Faster R-CNN), region-based fully convolutional neural network (R-FCN), you only look once (YOLO) networks, single-shot detector (SSD) networks, neural architecture search net (NASNet) networks, and mask region-based convolutional neural networks (Mask R-CNN).

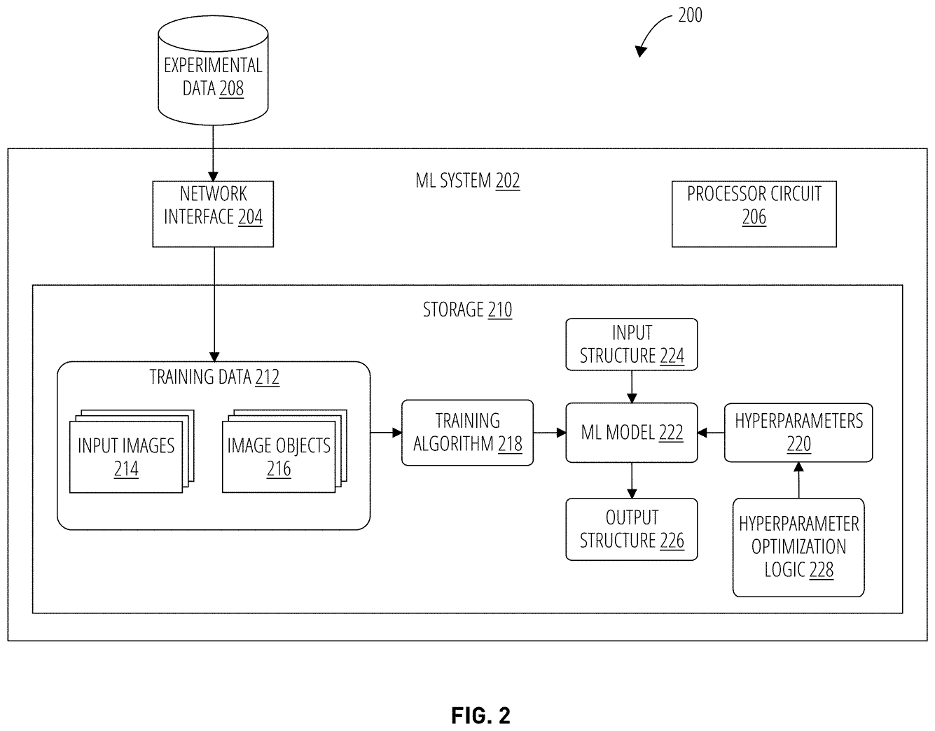

FIG. 2 depicts an ML environment 200 suitable for use with the present disclosure, specifically, for learning which activation function to use as well as providing a spike train of activations, which features will be described in greater detail below. The ML environment 200 may include an ML system 202, such as a computing device that applies an ML algorithm to learn relationships, such as, objects in images. As a specific example, ML system 202 can be implemented to apply an ML algorithm to learn to recognize objects in images and provide bounding box 110 and segmentation region 112 associated with the detected object.

The ML environment 200 may include an ML system 202, such as a computing device that applies an ML algorithm to learn relationships. As a specific example, ML system 202 can be implemented to apply an ML algorithm to learn to recognize objects in images. As noted, ML system 202 could be applied to train ML models as outlined herein for tasks other than computer vision, such as, for example, to learn relationships between biological cells (e.g., DNA, proteins, etc.), control behaviors for devices (e.g., robots, machines, etc.) or the like.

The ML system 202 may make use of experimental data 208. In general, experimental data 208 will include indications of data with which ML models employing the described activation functions and spike train activations are to be trained with. For example, experimental data 208 may include a number of images (e.g., images depicted in FIG. 1, or the like) and an indication of an object within the images (e.g., the cat, the dog, the cat and the dog, or the like).

As another example, experimental data 208 can include indications of robotic control movements (e.g., as provided by sensors in a robotic system, or the like). As another example, experimental data 208 may include pre-existing experimental data from databases, libraries, repositories, etc. The experimental data 208 may be collocated with the ML system 202 (e.g., stored in a storage 210 of the ML system 202), may be remote from the ML system 202 and accessed via a network interface 204, or may be a combination of local and remote data.

Experimental data 208 can be used to form training data 212. In some examples, training data 212 can be based on experimental data 208 as well as supplemented by data learned by modeling and simulating analogous data in software, and by parsing scientific and academic literature for such data. With some examples, commercially available datasets can be used, such as, the PASCAL Visual Object Classification (PASCAL VOC) and Common Objects in Context (COCO) datasets, the ImageNet dataset, or the like.

As noted above, the ML system 202 may include a storage 210, which may include a hard drive, solid state storage, and/or random access memory. The storage 210 may hold training data 212. For example, as in the case of object recognition in images, the training data 212 can include indications of input images 214 as well as image objects 216 associated with teach of input images 214.

The training data 212 may be applied to train an ML model 222. Depending on the particular application, different types of ML model 222 may be suitable for use. For instance, ML model 222 can be an artificial neural network (ANN) or a convoluted neural network (CNN). Generally, ML model 222 can be any ML model architecture where the nodes use activation functions to generate output and can be selected based on design goals, available resources, size of the data set of experimental data 208 and/or training data 212, or the like.

Furthermore, any training algorithm 218 may be used to train the ML model 222. Nonetheless, the example depicted in FIG. 2 may be particularly well-suited to a supervised training algorithm or reinforcement learning. For a supervised training algorithm, the ML system 202 may apply the input images 214 and image objects 216 to learn associations between the input images 214 and the image objects 216. In this case, the image objects 216 may be used as labels for the input images 214. In a reinforcement learning scenario, the the ML model 222 may infer image objects 216 from input images 214 and the inference can be “compared” or scored by comparing the inference to the actual objects tagged for each input images 214.

The training algorithm 218 may be applied using a processor circuit 206, which may include suitable hardware processing resources that operate on the logic and structures in the storage 210. The training algorithm 218 and/or the development of the trained ML model 222 may be at least partially dependent on model hyperparameters 220. The hyperparameters 220 may be automatically selected based on hyperparameter optimization logic 228, which may include the learning of activation function as described herein as well as the generation of spike train activations described herein. Other hyper parameters can include network structure (e.g., number of hidden units, or the like) or network learning (e.g., learning rate, or the like). Learning the hyperparameters related to the activation function as well as forming a spike train of activation is the focus of this disclosure and is described in greater detail herein.

In some embodiments, some of the training data 212 may be used to initially train the ML model 222, and some may be held back as a validation, or testing, subset. The portion of the training data 212 not including the validation subset may be used to train the ML model 222, whereas the validation subset may be held back and used to test the trained ML model 222 to verify that the ML model 222 is able to generalize its predictions to new data.

Once the ML model 222 is trained, it may be applied (by the processor circuit 206) to new input data. The new input data may include images to be classified. As a specific example, ML model 222 may be provisioned in a security setting to detect malicious or hazardous objects in images captured by security cameras. As another example, ML model 222 may be provisioned to detect objects (e.g., road signs, hazards, humans, pets, etc.) in images captured by cameras of an autonomous vehicle. The input to the ML model 222 may be formatted according to a predefined input structure 224 mirroring the way that the training data 212 was provided to the ML model 222. The ML model 222 may generate an output structure 226 which may be, for example, a classification of the image, a listing of detected objects, a boundary of detected objects, or the like.

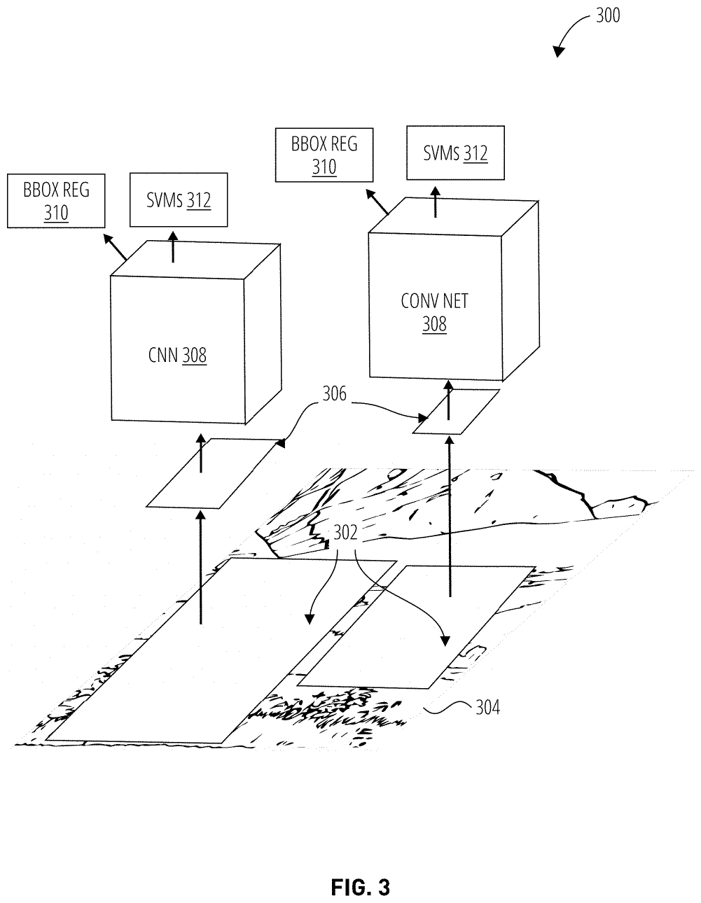

As contemplated herein, ML models 222 are trained to infer output for a particular task, such as, object recognition, or the like. As such, FIG. 3 illustrates an example of an R-CNN model 300, which can be applied as ML model 222 in ML system 202 of ML environment 200. Although R-CNN model 300 is depicted, other types of ML models 222 can be employed. Each region proposal feeds a convolutional neural network (CNN) to extract a features vector, possible objects are detected using multiple support vector machine (SVM) classifiers and a linear regressor modifies the coordinates of the bounding box. The regions of interest regions of interest (ROIs) 302 of the input image 304. Each ROI 302 is resized and/or warped creating the warped image region 306, which are forwarded to the CNNs 308, where they are feed to the support vector machines 312 and bounding box linear regressors 310.

In the R-CNN model 300, the selective search method is an alternative to exhaustive search in an image to capture object location. It initializes small regions in an image and merges them with a hierarchical grouping. Thus the final group is a box containing the entire image. The detected regions are merged according to a variety of color spaces and similarity metrics. The output is a few number of region proposals which could contain an object by merging small regions.

The R-CNN model 300 combines the selective search method to detect region proposals and deep learning to find out the object in these regions. Each region proposal is resized to match the input of CNNs 308, from which a vector of features (e.g., 4096-dimension, or the like) are extracted. The features vector is fed into multiple classifiers to produce probabilities to belong to each class. Each one of these classes has a support vector machines 312 (SVM) classifier trained to infer a probability to detect this object for a given vector of features. This vector also feeds a linear regressor to adapt the shapes of the bounding box for a region proposal and thus reduce localization errors.

The CNNs 308 described are trained using a dataset. It is fine-tuned using the region proposals corresponding to an IoU greater than 0.5 with the ground-truth boxes. Two versions are produced, one version is using the PASCAL VOC dataset and the other the ImageNet dataset with bounding boxes. The SVM classifiers are also trained for each class of each dataset.

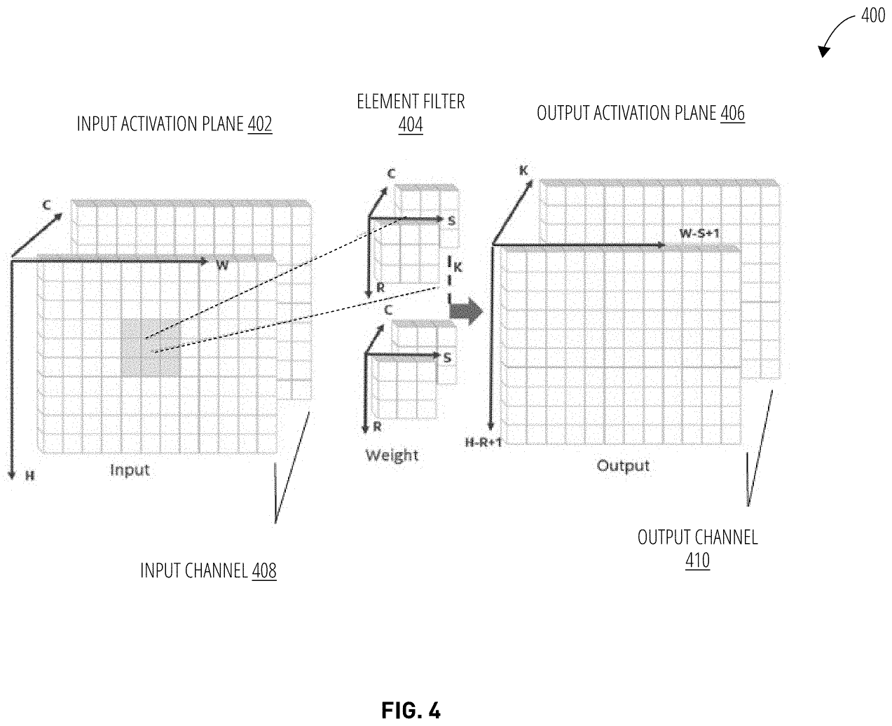

FIG. 4 illustrates an example CNN 400, in accordance with non-limiting example(s) of the present disclosure. As will be appreciated, computers read images as pixels, which is typically expressed as a matrix (Height (H)×Width (W)×Depth (D)). CNN 400 includes a number of layers which can be trained to detect specific features or patterns present in an input image (e.g., input images 214, or the like).

For example, CNN 400 depicts a (H×W) input activation plane 402. The convolution process involves sliding a two-dimensional (2D) element filter 404 (having dimensions S×R) over the input activation plane 402 to form output activation plane 406, which has dimensions ((W−S+1)×(H−R+1)). Generally speaking, the deriving values for output activation plane 406 involves deriving a dot product of the elements in the window of element filter 404 and determining an output based on an activation function as well as weights connecting the various layers of CNN 400. Conventionally, the activation function is selected manually, such as, for example, based on empirical data. However, the present disclosure provides to “learn” an activation function during the training process similar to how the weights are adjusted to produce desired outputs. This is described in greater detail below. Furthermore, the present disclosure provides that a spike train of activations is produced as opposed to a single scalar value for each activation. This is also described in greater detail below.

As depicted, input activation plane 402 includes a number of input channels 408 while output activation plane 406 includes output channels 410. With some examples, the channels can refer to the depth of the image, or other characteristics of the input data to be processed by CNN 400. In some examples, an element filter 404 can be applied to input channel 408 of the input activation plane 402, and the output from element filter 404 for each of the input channel 408 can be accumulated together, element-wise, into a single output channel 410. In other, or further examples, multiple (K) element filters 404 can be applied to the same volume of input activations (e.g., input channels 408 of input activation planes 402) to produce K output channels 410.

As elaborated above, the present disclosure provides a system and framework for training an ML model (e.g., ML model 222) where the activation function is one of the hyperparameters learned during training. To that end, the present disclosure provides an adaptive activation function (AAF), having parameters that are adjusted during training to dynamically change the activation function to achieve the learning objective. For example, an AAF provided herein can be AAF(x,a,b)=Dₐ ln (e^{-bx}+e^{x}), where “a” and “b” are hyperparameters 220 to be adjusted during training of ML model 222 and x is the input. In the above example, parameter “a” selects the order of the derivative in a fractional fashion while parameter “b” allows the function to move between families of activation functions (e.g., tan h, relu, sigmoid). The above activation function is derived from the primitive function of a hyperbolic tangent, which is ln(cos h(x)) and the primitive function of a sigmoid, which is ln(1+e^{x}). Accordingly, by defining the fractional order of the derivative of a given primitive activation function, this fractional order can be tuned as an additional training hyperparameters for intrafamily selection (e.g., “a”) and for cross family selection (e.g., “b”). The AAF detailed in the equation above can also be expressed as AAF(x)=ln(e^{x}+q^{-bx})−a ln(e^{(x-1)}+e^{-b(x-1)}), where “a” and “b” are again hyperparameters as detailed above.

By providing an adaptive activation function as outlined above and by including parameters of the activation function in the hyperparameters to be optimized during training, the present methodology enables the neural network to search and optimize its own activation functions during the training process. Accordingly, activations within the network (e.g., output activation planes 406, output from neurons, or the like) can adjust their activation functions, on an individual basis, to best fit the input data and reduce errors in the output. It is noted, as already stated, that although the present disclosure provides an example using image classification and CNNs, the adaptive activation function discussed herein could be applied to other types of networks with neurons that “fire” or activate to generate an output, such as, for example, a multi-layer perceptron (MLP) network, a radial basis function (RBF) network, or the like.

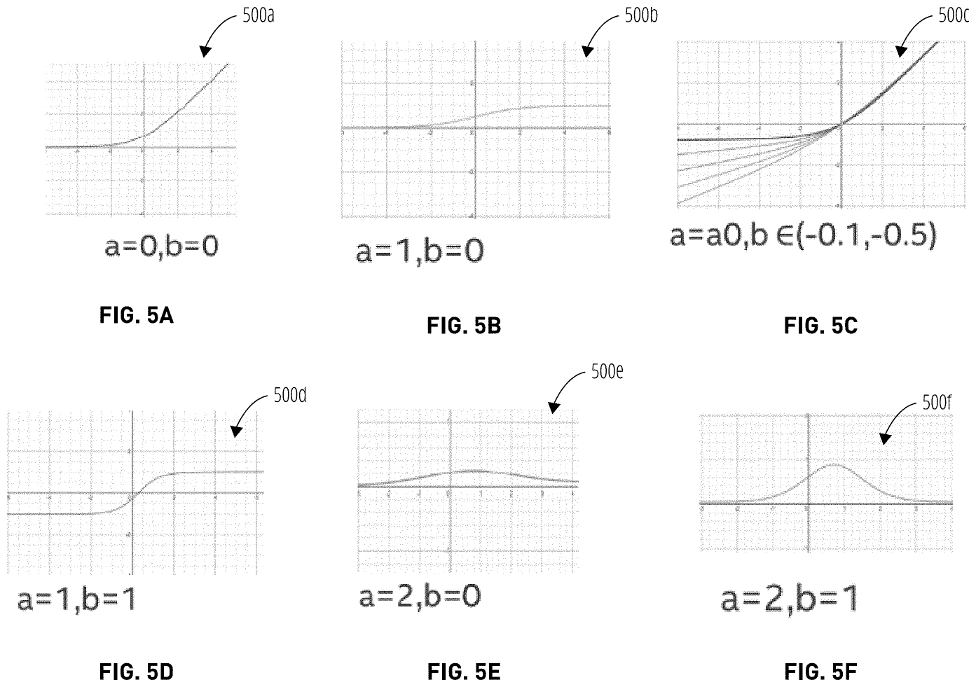

Examples of various activation functions that can be learned as outlined herein are depicts in FIG. 5A to FIG. 5F. For example, FIG. 5A illustrates a graph 500a of the above adaptive activation function where “a” and “b” are zero, which approximates the SoftPlus activation function.

FIG. 5B illustrates a graph 500b of the above adaptive activation function where a=1 and b=0, which approximates the Sigmoid activation function.

FIG. 5C illustrates a graph 500c of the above adaptive activation function where a=0 and b∈[−0.1, −0.5], which approximates the LeakyReLU activation function.

FIG. 5D illustrates a graph 500d of the above adaptive activation function where a=1 and b=1, which approximates the Hyperbolic Tangent activation function.

FIG. 5E illustrates a graph 500e of the above adaptive activation function where a=2 and b=0, which approximates the Gaussian activation function with a first deviation.

FIG. 5F illustrates a graph 500f of the above adaptive activation function where a=2 and b=1, which approximates the Gaussian activation function with a second deviation different from the deviation of the activation function depicted in graph 500e of FIG. 5E.

Thus, as will be appreciated, an adaptive activation function is provided where parameters of the activation function can be adjusted during training of an ML model to provide individual activation functions for each neuron in the model.

Further, as will be appreciated, in traditional CNN, there is an activation function associated with each channel, and it is applied after the convolution (e.g., as described above). In the traditional convolutional layers, the number of output images is equal to the number of element filters 404, then the only way to add more output images is by adding more element filters 404. As a consequence, the number of element filters 404 and the number of multiply-add (MAC) operations increases in proportion to the number of inputs. For instance, if the layer has 6 input images, the addition of one extra output requires six additional element filters 404.

The present disclosure provides a “spike train” of activations allowing for generation of multichannel output images based on the adaptive activation function described above, as opposed to using a single activation function per convolutional unit.

As used herein, the term “spike train” refers to a vector of activations as opposed to a single scalar activation. To that end, for each layer in an ML model (e.g., ML model 222, or the like) a set S_{AAF} of adaptive activation functions (AAFs) are trained, where the AAFs are shared across a given layer of the network. During a forward pass through the network, S_{AAF} is applied to the pre-activation tensor of the current layer so that each neuron, kernel, or element, has a vector of activations associated with it.

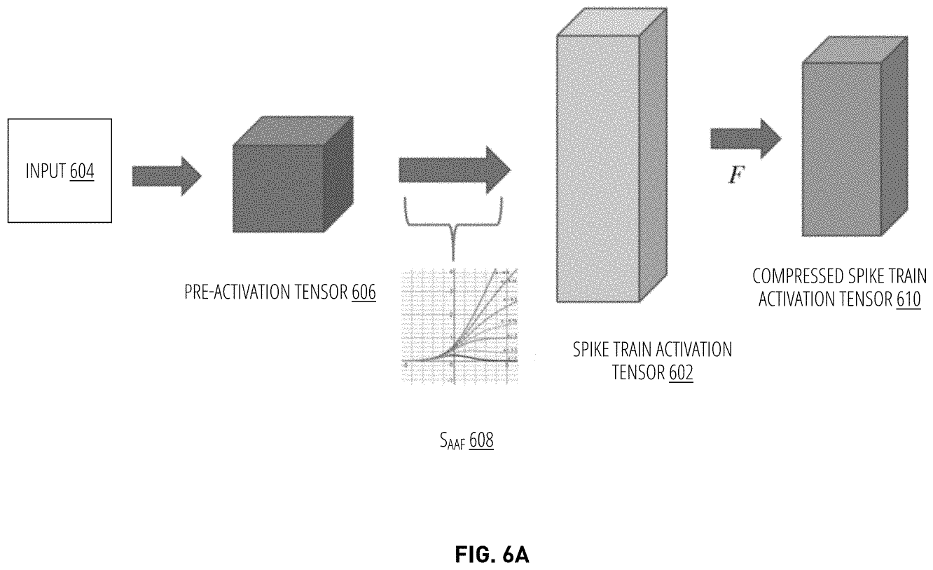

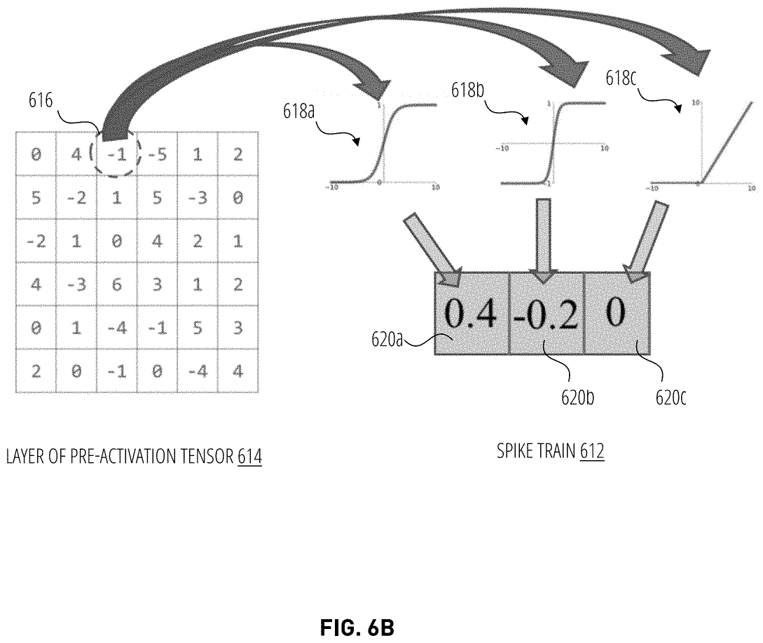

FIG. 6A depicts a spike train activation tensor 602 generated based on the present disclosure. As depicted, inputs 604 are processed to form a pre-activation tensor 606, which is further processed by S_{AAF} 608 to form spike train activation tensor 602.

In some examples, spike train activation tensor 602 can be compressed to form compressed spike train activation tensor 610. As a specific example, spike train activation tensor 602 can be compressed based on a dimensionality reduction technique (e.g., simple linear model, or the like).

Generation of a spike train 612 is more specifically illustrated in FIG. 6B. This figure depicts a layer 614 of pre-activation tensor 606. As will be appreciated, the layer 614 of pre-activation tensor 606 includes a number of input values, such as, input value 616. Conventionally, each input value 616 is processed by the same activation function. However, as outlined above, each value could have an AAF associated with the input value. That is, a different AAF could be “learned” for each value of layer 614 of pre-activation tensor 606. Furthermore, the present disclosure provides that multiple AAFs (e.g., AAF 618a, AAF 618b, and 618c, or the like) can be “learned” for each value of layer 614 of pre-activation tensor 606. In this manner, a vector of activations for each value can be generated. For example, this figure depicts spike train 612 including activation value 620a, 620b, and 620c generated from input value 616 and AAF 618a, 618b, and 618c, respectively.

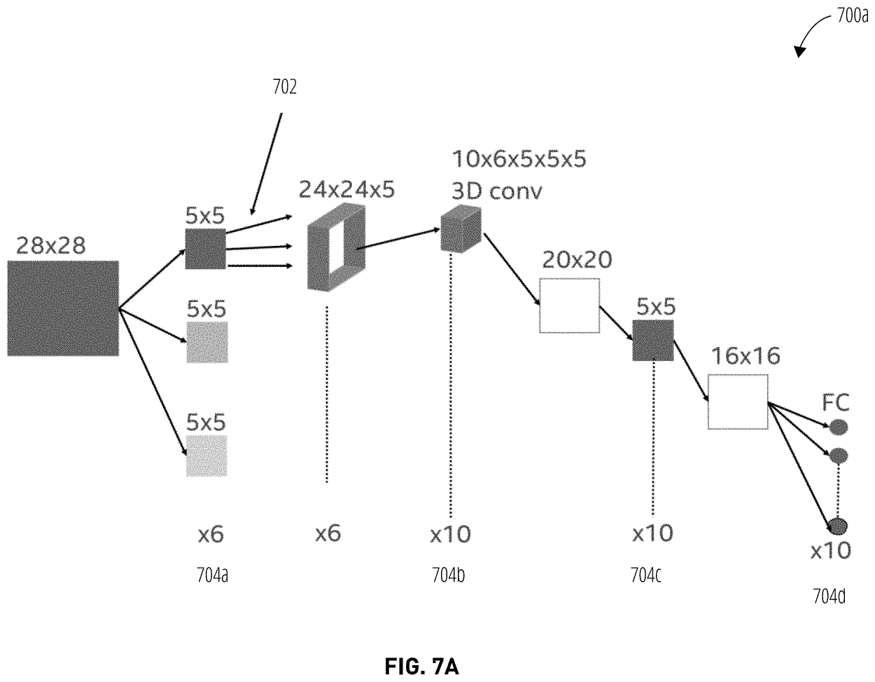

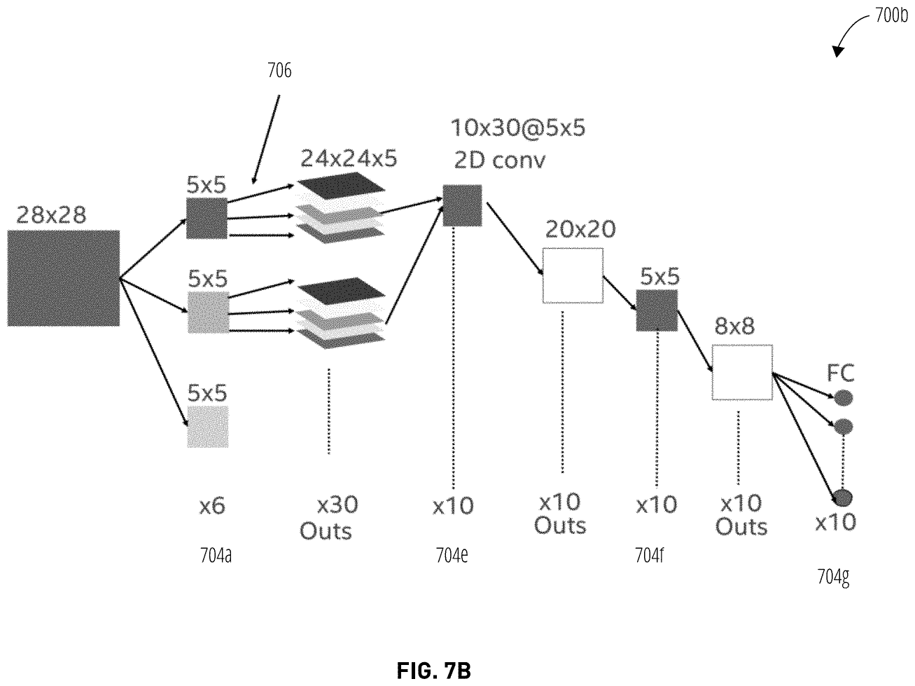

FIG. 7A and FIG. 7B illustrate networks, in accordance with non-limiting example(s) of the present disclosure based on the following topology: 6conv-2d, 10conv-2d, 10conv-2d, 10FC. Said differently, the network topology is six (6) convolutional units in the first layer, ten (10) convolutional filters in the second layer having six inputs each, ten (10) convolutional filters in the third layer with ten input images each and lastly fully connected units, where all generated images are 2D. More particularly, FIG. 7A depicts network 700a based on AAFs as described herein while FIG. 7B depicts network 700b based on AAFs and spike train activations.

Turning more specifically to FIG. 7A, network 700a depicts a first layer 704a of five (5) outputs having five (5) AAFs 702, in this way instead of having six (6) 2D images as output, the network 700a has six (6) 3D tensors (e.g., 3D images) of (24×24×5). The next layer 704b has ten 3D convolutional units with (5×5×5) kernels generating as outputs ten (10) 2D images of 20×20. A third layer 704c provides ten (10) convolutional units using (5×5) kernels to generate images of 16×16. Finally, layer 704d corresponding to a fully connected layer is depicted.

Using experimental data from the MNIST dataset, network 700a produced an accuracy of 99.47%, which is considered high. However, as illustrated, network 700a required the use of 3D convolutional kernels in layer 704b.

FIG. 7B illustrates network 700b, where layer 704a is the same. However, instead of representing the output from layer 704a as six (6) 3D tensors, the images were stacked in a single array as 2D images having 30 output images (6×5), based on spike train activations. In this manner, the 3D convolutional tensor from layer 704b in network 700a is replaced by a 2D convolution, represented in layer 704e.

Additionally, network 700b depicts a third layer 704f where a max pooling operation was used to reduce the size of the images and as a result, the number of inputs to the fully connected layer 704g. Using the same MNIST dataset, network 700b produced 99.36% accuracy.

Each network was compared using 30 kernels in the first layer, which were applied to generate the 30 output images. It is noted that both network topologies produce similar accuracy. However, the second network topology (e.g., network 700b) reduced the number of operations in the first layer from 432K MAC operations to 86.4K MAC operations. Furthermore, the topology for network 700b requires significantly less parameters to define the convolutional kernels. Specifically, 750 weights define the 30×5×5 kernel from network 700a whereas 210 weights define the kernels in network 700b.

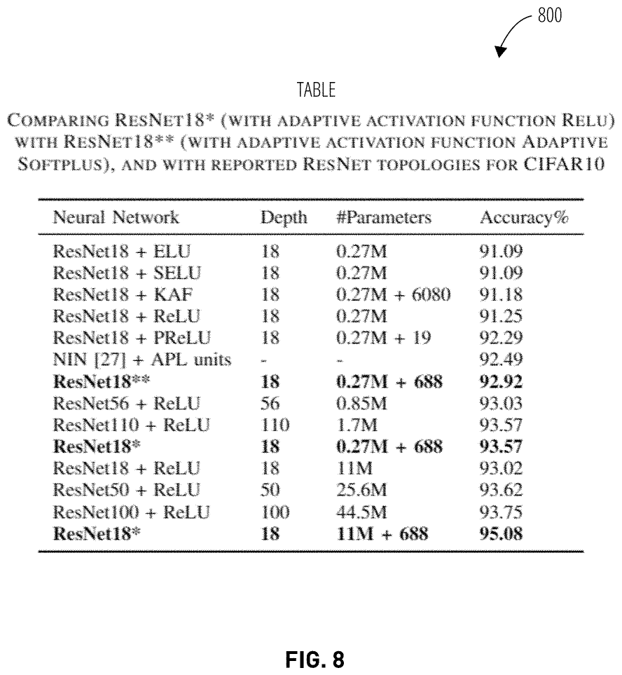

FIG. 8 illustrates a table 800, detailing accuracy of networks using AAFs as well as potential compute savings versus conventional networks that do not use AAFs. As depicted in this table, provisioning a network with AAFs generates an increase in accuracy of at least 1% and up to 66× compute savings. Combining the above detailed AAFs with spike trains would provide an even greater savings in compute versus just AAFs alone.

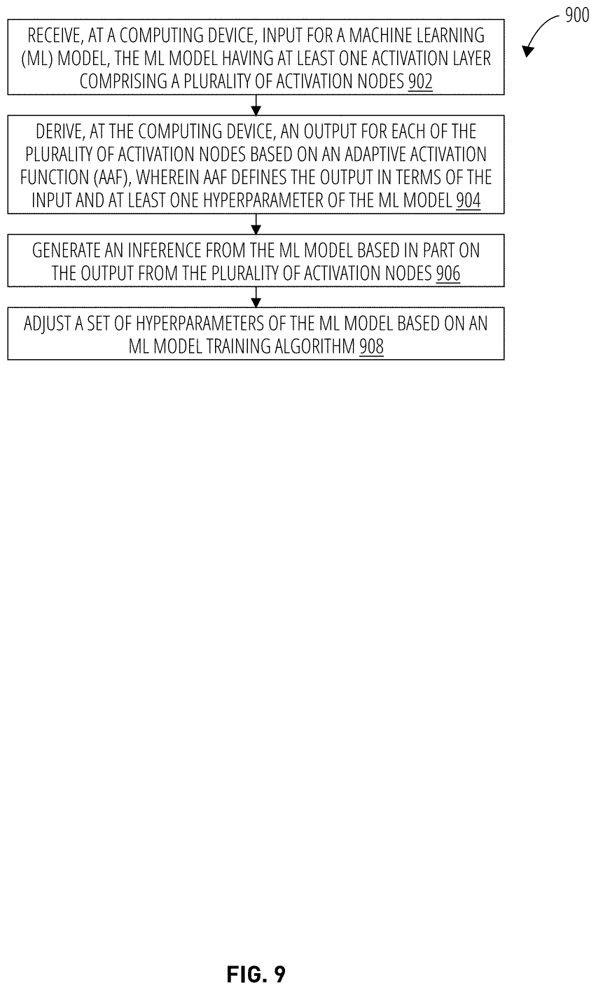

FIG. 9 illustrates a routine 900, in accordance with non-limiting example(s) of the present disclosure. Routine 900 can be provided to generate an inference from an ML model comprising an AAF and a set of AAFs as described herein. Routine 900 can begin at block 902, where routine 900 receives, at a computing device, input for a machine learning (ML) model, the ML model having at least one activation layer comprising a plurality of activation nodes. For example, ML system 202 can receive input images 214 to be processed by ML model 222 where ML model 222 includes AAFs as described herein.

Continuing to block 904, where routine 900 derives, at the computing device, an output for each of the plurality of activation nodes based on an adaptive activation function (AAF), wherein AAF defines the output in terms of the input and at least one hyperparameter of the ML model. Continuing to block 906, routine 900 generates an inference from the ML model based in part on the output from the plurality of activation nodes. In general, this can be referred to as a forward pass through the ML model.

Routine 900 can further include a training pass (e.g., backward pass, or the like) through the ML model to adjust the hyperparameters of the model, including block 908, where routine 900 adjusts a set of hyperparameters of the ML model based on an ML model training algorithm.

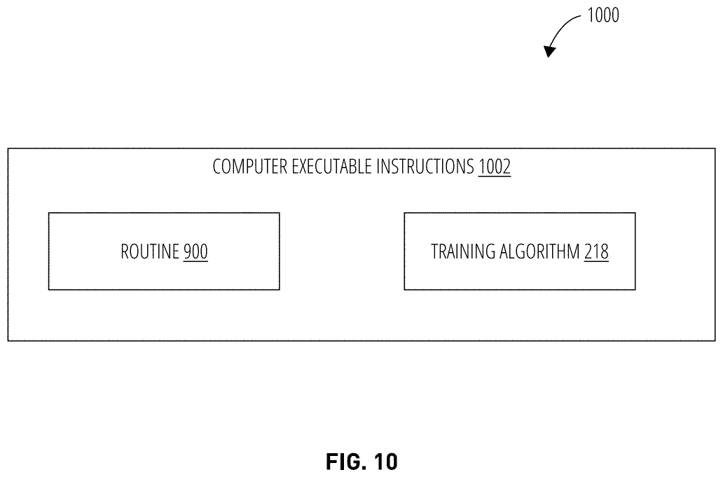

FIG. 10 illustrates computer-readable storage medium 1000. Computer-readable storage medium 1000 may comprise any non-transitory computer-readable storage medium or machine-readable storage medium, such as an optical, magnetic or semiconductor storage medium. In various embodiments, computer-readable storage medium 1000 may comprise an article of manufacture. In some embodiments, computer-readable storage medium 1000 may store computer executable instructions 1002 with which circuitry (e.g., processor circuit 206, or the like) can execute. For example, computer executable instructions 1002 can include instructions to implement operations described with respect to routine 900 and/or training algorithm 218. Examples of computer-readable storage medium 1000 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1002 may include any suitable type of code, such as source code, compiled code, interpreted code, executable code, static code, dynamic code, object-oriented code, visual code, and the like.

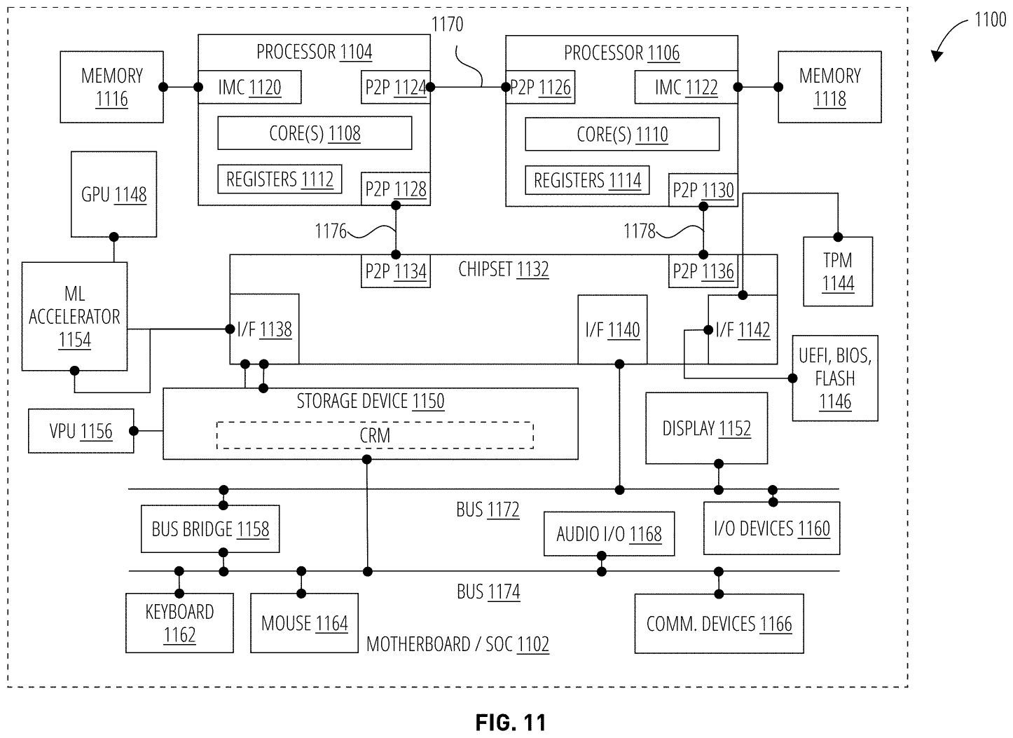

FIG. 11 illustrates an embodiment of a system 1100. System 1100 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 1100 may have a single processor with one core or more than one processor. Note that the term “processor” refers to a processor with a single core or a processor package with multiple processor cores. In at least one embodiment, the computing system 1100 is representative of the components of the ML environment 200. More generally, the computing system 1100 is configured to implement all logic, systems, logic flows, methods, apparatuses, and functionality described herein with reference to the prior figures.

As used in this application, the terms “system” and “component” and “module” are intended to refer to a computer-related entity, either hardware, a combination of hardware and software, software, or software in execution, examples of which are provided by the exemplary system 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 1100 comprises a motherboard or system-on-chip(SoC) 1102 for mounting platform components. Motherboard or system-on-chip(SoC) 1102 is a point-to-point (P2P) interconnect platform that includes a first processor 1104 and a second processor 1106 coupled via a point-to-point interconnect 1170 such as an Ultra Path Interconnect (UPI). In other embodiments, the system 1100 may be of another bus architecture, such as a multi-drop bus. Furthermore, each of processor 1104 and processor 1106 may be processor packages with multiple processor cores including core(s) 1108 and core(s) 1110, respectively as well as multiple registers, memories, or caches, such as, registers 1112 and registers 1114, respectively. While the system 1100 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processor 1104 and chipset 1132. Some platforms may include additional components and some platforms may only include sockets to mount the processors and/or the chipset. Furthermore, some platforms may not have sockets (e.g. SoC, or the like).

The processor 1104 and processor 1106 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi processor architectures may also be employed as the processor 1104 and/or processor 1106. Additionally, the processor 1104 need not be identical to processor 1106.

Processor 1104 includes an integrated memory controller (IMC) 1120 and point-to-point (P2P) interface 1124 and P2P interface 1128. Similarly, the processor 1106 includes an IMC 1122 as well as P2P interface 1126 and P2P interface 1130. IMC 1120 and IMC 1122 couple the processors processor 1104 and processor 1106, respectively, to respective memories (e.g., memory 1116 and memory 1118). Memory 1116 and memory 1118 may be portions of the main memory (e.g., a dynamic random-access memory (DRAM)) for the platform such as double data rate type 3 (DDR3) or type 4 (DDR4) synchronous DRAM (SDRAM). In the present embodiment, the memories memory 1116 and memory 1118 locally attach to the respective processors (i.e., processor 1104 and processor 1106). In other embodiments, the main memory may couple with the processors via a bus and shared memory hub.

System 1100 includes chipset 1132 coupled to processor 1104 and processor 1106. Furthermore, chipset 1132 can be coupled to storage device 1150, for example, via an interface (I/F) 1138. The I/F 1138 may be, for example, a Peripheral Component Interconnect-enhanced (PCI-e). Storage device 1150 can store instructions executable by circuitry of system 1100 (e.g., processor 1104, processor 1106, GPU 1148, ML accelerator 1154, vision processing unit 1156, or the like). For example, storage device 1150 can store instructions for training algorithm 218, or the like.

Processor 1104 couples to a chipset 1132 via P2P interface 1128 and P2P 1134 while processor 1106 couples to a chipset 1132 via P2P interface 1130 and P2P 1136. Direct media interface (DMI) 1176 and DMI 1178 may couple the P2P interface 1128 and the P2P 1134 and the P2P interface 1130 and P2P 1136, respectively. DMI 1176 and DMI 1178 may be a high-speed interconnect that facilitates, e.g., eight Giga Transfers per second (GT/s) such as DMI 3.0. In other embodiments, the processor 1104 and processor 1106 may interconnect via a bus.

The chipset 1132 may comprise a controller hub such as a platform controller hub (PCH). The chipset 1132 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 1132 may comprise more than one controller hub such as a chipset with a memory controller hub, a graphics controller hub, and an input/output (I/O) controller hub.

In the depicted example, chipset 1132 couples with a trusted platform module (TPM) 1144 and UEFI, BIOS, FLASH circuitry 1146 via I/F 1142. The TPM 1144 is a dedicated microcontroller designed to secure hardware by integrating cryptographic keys into devices. The UEFI, BIOS, FLASH circuitry 1146 may provide pre-boot code.

Furthermore, chipset 1132 includes the I/F 1138 to couple chipset 1132 with a high-performance graphics engine, such as, graphics processing circuitry or a graphics processing unit (GPU) 1148. In other embodiments, the system 1100 may include a flexible display interface (FDI) (not shown) between the processor 1104 and/or the processor 1106 and the chipset 1132. The FDI interconnects a graphics processor core in one or more of processor 1104 and/or processor 1106 with the chipset 1132.

Additionally, ML accelerator 1154 and/or vision processing unit 1156 can be coupled to chipset 1132 via I/F 1138. ML accelerator 1154 can be circuitry arranged to execute ML related operations (e.g., training, inference, etc.) for ML models. Likewise, vision processing unit 1156 can be circuitry arranged to execute vision processing specific or related operations. In particular, ML accelerator 1154 and/or vision processing unit 1156 can be arranged to execute mathematical operations and/or operands useful for machine learning, neural network processing, artificial intelligence, vision processing, etc.

Various I/O devices 1160 and display 1152 couple to the bus 1172, along with a bus bridge 1158 which couples the bus 1172 to a second bus 1174 and an I/F 1140 that connects the bus 1172 with the chipset 1132. In one embodiment, the second bus 1174 may be a low pin count (LPC) bus. Various devices may couple to the second bus 1174 including, for example, a keyboard 1162, a mouse 1164 and communication devices 1166.

Furthermore, an audio I/O 1168 may couple to second bus 1174. Many of the I/O devices 1160 and communication devices 1166 may reside on the motherboard or system-on-chip(SoC) 1102 while the keyboard 1162 and the mouse 1164 may be add-on peripherals. In other embodiments, some or all the I/O devices 1160 and communication devices 1166 are add-on peripherals and do not reside on the motherboard or system-on-chip(SoC) 1102.

The following examples pertain to further embodiments, from which numerous permutations and configurations will be apparent.

### Example 1

A computing apparatus comprising: a processor; and a memory storing instructions that, when executed by the processor, configure the apparatus to: receive, at a computing device, input for a machine learning (ML) model, the ML model having at least one activation layer comprising a plurality of activation nodes; derive, at the computing device, an output for each of the plurality of activation nodes based on an adaptive activation function (AAF), wherein AAF defines the output in terms of the input and at least one hyperparameter of the ML model; and generate an inference from the ML model based in part on the output from the plurality of activation nodes.

### Example 2

The computing apparatus of claim 1, the instructions, when executed by the processor to configure the apparatus to derive an output for each of the plurality of activation nodes, configure the apparatus to: derive, for a first one of the plurality of activation nodes, an output based on the AAF and a first value for the at least one hyperparameter; and derive, for a second one of the plurality of activation nodes, an output based on the AAF and a second value for the at least one hyperparameter, wherein the second value is different than the first value.

### Example 3

The computing apparatus of claim 1, the instructions, when executed by the processor to configure the apparatus to adjust a set of hyperparameters of the ML model based on an ML model training algorithm, wherein the set of hyperparameters comprises an indication of the at least one hyperparameter for each of the plurality of activation nodes.

### Example 4

The computing apparatus of claim 1, the instructions, when executed by the processor to configure the apparatus to derive, at the computing device, a spike train output for each of the plurality of activation nodes based on a set of AAFs, wherein the set of AAFs comprise the AAF.

### Example 5

The computing apparatus of claim 1, wherein the at least one hyperparameter comprises a first hyperparameter “a” and a second hyperparameter “b” and wherein the AAF is defined by the following function AAF(x)=ln(e^{x}+e^{-bx})−a ln(e^{(x-1)}+e^{-b(x-1)}) where “ln” is the natural log, “e” is the natural exponential, “a” is the first hyperparameter, “b” is the second hyperparameter, and “x” is the input.

### Example 6

The computing apparatus of claim 1, the instructions, when executed by the processor to configure the apparatus to: receive indications of an image from an image capture device coupled to the apparatus; and generate the input from the indications of the image, wherein the inference comprising an indication of an object represented in the image.

### Example 7

The computing apparatus of claim 6, the instructions, when executed by the processor to configure the apparatus to generate a control signal for an autonomous vehicle based on the inference.

### Example 8

A non-transitory computer-readable storage medium, the computer-readable storage medium including instructions that when executed by a computer, cause the computer to: receive, at a computing device, input for a machine learning (ML) model, the ML model having at least one activation layer comprising a plurality of activation nodes; derive, at the computing device, an output for each of the plurality of activation nodes based on an adaptive activation function (AAF), wherein AAF defines the output in terms of the input and at least one hyperparameter of the ML model; and generate an inference from the ML model based in part on the output from the plurality of activation nodes.

### Example 9

The computer-readable storage medium of claim 8, the instructions, when executed by the computer to derive an output for each of the plurality of activation nodes cause the computer to: derive, for a first one of the plurality of activation nodes, an output based on the AAF and a first value for the at least one hyperparameter; and derive, for a second one of the plurality of activation nodes, an output based on the AAF and a second value for the at least one hyperparameter, wherein the second value is different than the first value.

### Example 10

The computer-readable storage medium of claim 8, the instructions, when executed by the computer, cause the computer to adjust a set of hyperparameters of the ML model based on an ML model training algorithm, wherein the set of hyperparameters comprises an indication of the at least one hyperparameter for each of the plurality of activation nodes.

### Example 11

The computer-readable storage medium of claim 8, the instructions, when executed by the computer, cause the computer to derive, at the computing device, a spike train output for each of the plurality of activation nodes based on a set of AAFs, wherein the set of AAFs comprise the AAF.

### Example 12

The computer-readable storage medium of claim 8, wherein the at least one hyperparameter comprises a first hyperparameter “a” and a second hyperparameter “b” and wherein the AAF is defined by the following function AAF(x)=ln(e^{x}+e^{-bx})−a ln(e^{(x-1)}+e^{-b(x-1)}) where “ln” is the natural log, “e” is the natural exponential, “a” is the first hyperparameter, “b” is the second hyperparameter, and “x” is the input.

### Example 13

The computer-readable storage medium of claim 8, the instructions, when executed by the computer, cause the computer to: receive indications of an image from an image capture device coupled to the computer; and generate the input from the indications of the image, wherein the inference comprising an indication of an object represented in the image.

### Example 14

The computer-readable storage medium of claim 13, the instructions, when executed by the computer, cause the computer to generate a control signal for an autonomous vehicle based on the inference.

### Example 15

A method, comprising: receiving, at a computing device, input for a machine learning (ML) model, the ML model having at least one activation layer comprising a plurality of activation nodes; deriving, at the computing device, an output for each of the plurality of activation nodes based on an adaptive activation function (AAF), wherein AAF defines the output in terms of the input and at least one hyperparameter of the ML model; and generating an inference from the ML model based in part on the output from the plurality of activation nodes.

### Example 16

The method of claim 15, comprising deriving an output for each of the plurality of activation nodes comprises: deriving, for a first one of the plurality of activation nodes, an output based on the AAF and a first value for the at least one hyperparameter; and deriving, for a second one of the plurality of activation nodes, an output based on the AAF and a second value for the at least one hyperparameter, wherein the second value is different than the first value.

### Example 17

The method of claim 15, comprising adjusting a set of hyperparameters of the ML model based on an ML model training algorithm, wherein the set of hyperparameters comprises an indication of the at least one hyperparameter for each of the plurality of activation nodes.

### Example 18

The method of claim 15, comprising deriving, at the computing device, a spike train output for each of the plurality of activation nodes based on a set of AAFs, wherein the set of AAFs comprise the AAF.

### Example 19

The method of claim 15, wherein the at least one hyperparameter comprises a first hyperparameter “a” and a second hyperparameter “b” and wherein the AAF is defined by the following function AAF(x)=ln(e^{x}+e^{-bx})−a ln(e^{(x-1)}+e^{-b(x-1)}) where “ln” is the natural log, “e” is the natural exponential, “a” is the first hyperparameter, “b” is the second hyperparameter, and “x” is the input.

### Example 20

The method of claim 15, comprising: receiving indications of an image from an image capture device coupled to the computing device; and generating the input from the indications of the image, wherein the inference comprising an indication of an object represented in the image.

### Example 21

The method of claim 20, comprising generating a control signal for an autonomous vehicle based on the inference.

### Example 22

An apparatus, comprising: means for receiving, at a computing device, input for a machine learning (ML) model, the ML model having at least one activation layer comprising a plurality of activation nodes; means for deriving, at the computing device, an output for each of the plurality of activation nodes based on an adaptive activation function (AAF), wherein AAF defines the output in terms of the input and at least one hyperparameter of the ML model; and means for generating an inference from the ML model based in part on the output from the plurality of activation nodes.

### Example 23

The apparatus of claim 22, the means for deriving an output for each of the plurality of activation nodes comprising: means for deriving, for a first one of the plurality of activation nodes, an output based on the AAF and a first value for the at least one hyperparameter; and means for deriving, for a second one of the plurality of activation nodes, an output based on the AAF and a second value for the at least one hyperparameter, wherein the second value is different than the first value.

### Example 24

The apparatus of claim 22, comprising means for adjusting a set of hyperparameters of the ML model based on an ML model training algorithm, wherein the set of hyperparameters comprises an indication of the at least one hyperparameter for each of the plurality of activation nodes.

### Example 25

The apparatus of claim 22, comprising means for deriving, at the computing device, a spike train output for each of the plurality of activation nodes based on a set of AAFs, wherein the set of AAFs comprise the AAF.

### Example 26

The apparatus of claim 22, wherein the at least one hyperparameter comprises a first hyperparameter “a” and a second hyperparameter “b” and wherein the AAF is defined by the following function AAF(x)=ln(e^{x}+e^{-bx})−a ln(e^{(x-1)}+e^{-b(x-1)}), where “ln” is the natural log, “e” is the natural exponential, “a” is the first hyperparameter, “b” is the second hyperparameter, and “x” is the input.

### Example 27

The apparatus of claim 22, comprising: means for receiving indications of an image from an image capture device coupled to the apparatus; and means for generating the input from the indications of the image, wherein the inference comprising an indication of an object represented in the image.

### Example 28

The apparatus of claim 27, comprising means for generating a control signal for an autonomous vehicle based on the inference.

Other technical features may be readily apparent to one skilled in the art from the following figures, descriptions, and claims.

In addition, in the foregoing, various features are grouped together in a single example to streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A computing apparatus comprising:
a processor; and
a memory storing instructions that, when executed by the processor, configure the apparatus to:
receive, at a computing device, input for a machine learning (ML) model, the ML model having at least one activation layer comprising a plurality of activation nodes;
derive, at the computing device, an output for each of the plurality of activation nodes based on an adaptive activation function (AAF), wherein the AAF defines the output in terms of the input and at least one hyperparameter of the ML model; and
generate an inference from the ML model based in part on the output from the plurality of activation nodes.

2. The computing apparatus of claim 1, the instructions, when executed by the processor to configure the apparatus to derive an output for each of the plurality of activation nodes, configure the apparatus to:
derive, for a first one of the plurality of activation nodes, an output based on the AAF and a first value for the at least one hyperparameter; and
derive, for a second one of the plurality of activation nodes, an output based on the AAF and a second value for the at least one hyperparameter, wherein the second value is different than the first value.

3. The computing apparatus of claim 1, the instructions, when executed by the processor configure the apparatus to adjust a set of hyperparameters of the ML model based on an ML model training algorithm, wherein the set of hyperparameters comprises an indication of the at least one hyperparameter for each of the plurality of activation nodes.

4. The computing apparatus of claim 1, the instructions, when executed by the processor configure the apparatus to derive a spike train output for each of the plurality of activation nodes based on a set of AAFs, wherein the set of AAFs comprise the AAF.

5. The computing apparatus of claim 1, wherein the at least one hyperparameter comprises a first hyperparameter “a” and a second hyperparameter “b” and wherein the AAF is defined by the following function AAF(x)=ln(e^{x}+e^{-b}x)−a ln(e^{(x-1)}+e^{-b(x-1)}), where “ln” is the natural log, “e” is the natural exponential, “a” is the first hyperparameter, “b” is the second hyperparameter, and “x” is the input.

6. The computing apparatus of claim 1, the instructions, when executed by the processor configure the apparatus to:
receive indications of an image from an image capture device coupled to the computing apparatus; and
generate the input from the indications of the image, wherein the inference comprising an indication of an object represented in the image.

7. The computing apparatus of claim 6, the instructions, when executed by the processor configure the apparatus to generate a control signal for an autonomous vehicle based on the inference.

8. A non-transitory computer-readable storage medium, the computer-readable storage medium including instructions that when executed by a computer, cause the computer to:
receive, at a computing device, input for a machine learning (ML) model, the ML model having at least one activation layer comprising a plurality of activation nodes;
derive, at the computing device, an output for each of the plurality of activation nodes based on an adaptive activation function (AAF), wherein AAF defines the output in terms of the input and at least one hyperparameter of the ML model; and
generate an inference from the ML model based in part on the output from the plurality of activation nodes.

9. The computer-readable storage medium of claim 8, the instructions, when executed by the computer to derive an output for each of the plurality of activation nodes cause the computer to:
derive, for a first one of the plurality of activation nodes, an output based on the AAF and a first value for the at least one hyperparameter; and
derive, for a second one of the plurality of activation nodes, an output based on the AAF and a second value for the at least one hyperparameter, wherein the second value is different than the first value.

10. The computer-readable storage medium of claim 8, the instructions, when executed by the computer, cause the computer to adjust a set of hyperparameters of the ML model based on an ML model training algorithm, wherein the set of hyperparameters comprises an indication of the at least one hyperparameter for each of the plurality of activation nodes.

11. The computer-readable storage medium of claim 8, the instructions, when executed by the computer, cause the computer to derive, at the computing device, a spike train output for each of the plurality of activation nodes based on a set of AAFs, wherein the set of AAFs comprise the AAF.

12. The computer-readable storage medium of claim 8, wherein the at least one hyperparameter comprises a first hyperparameter “a” and a second hyperparameter “b” and wherein the AAF is defined by the following function AAF(x)=ln(e^{x}+e^{-bx})−a ln(e^{(x-1)}+e^{-b(x-1)}), where “ln” is the natural log, “e” is the natural exponential, “a” is the first hyperparameter, “b” is the second hyperparameter, and “x” is the input.

13. The computer-readable storage medium of claim 8, the instructions, when executed by the computer, cause the computer to:
receive indications of an image from an image capture device coupled to the computer; and
generate the input from the indications of the image, wherein the inference comprising an indication of an object represented in the image.

14. The computer-readable storage medium of claim 13, the instructions, when executed by the computer, cause the computer to generate a control signal for an autonomous vehicle based on the inference.

15. An apparatus, comprising:
means for receiving, at a computing device, input for a machine learning (ML) model, the ML model having at least one activation layer comprising a plurality of activation nodes;
means for deriving, at the computing device, an output for each of the plurality of activation nodes based on an adaptive activation function (AAF), wherein AAF defines the output in terms of the input and at least one hyperparameter of the ML model; and
means for generating an inference from the ML model based in part on the output from the plurality of activation nodes.

16. The apparatus of claim 15, the means for deriving an output for each of the plurality of activation nodes comprising:
means for deriving, for a first one of the plurality of activation nodes, an output based on the AAF and a first value for the at least one hyperparameter; and
means for deriving, for a second one of the plurality of activation nodes, an output based on the AAF and a second value for the at least one hyperparameter, wherein the second value is different than the first value.

17. The apparatus of claim 15, comprising means for adjusting a set of hyperparameters of the ML model based on an ML model training algorithm, wherein the set of hyperparameters comprises an indication of the at least one hyperparameter for each of the plurality of activation nodes.

18. The apparatus of claim 15, comprising means for deriving, at the computing device, a spike train output for each of the plurality of activation nodes based on a set of AAFs, wherein the set of AAFs comprise the AAF.

19. The apparatus of claim 15, wherein the at least one hyperparameter comprises a first hyperparameter “a” and a second hyperparameter “b” and wherein the AAF is defined by the following function AAF(x)=ln(e^{x}+e^{-bx})−a ln(e^{(x-1)}+e^{-b(x-1)}), where “ln” is the natural log, “e” is the natural exponential, “a” is the first hyperparameter, “b” is the second hyperparameter, and “x” is the input.

20. The apparatus of claim 15, comprising:
means for receiving indications of an image from an image capture device coupled to the apparatus; and
means for generating the input from the indications of the image, wherein the inference comprising an indication of an object represented in the image.

21. The apparatus of claim 20, comprising means for generating a control signal for an autonomous vehicle based on the inference.
